(19) United States
(12) Patent Application Publication
(10) Pub. No.: US 2006/0064846 A1
(43) Pub. Date: Mar. 30, 2006

(54) Electric supply system for the door of refrigerators and freezers

(75) Inventors: Estevao Marino Espindola, Joinville-Sc (BR); Ademar Testoni, Joinville-Sc (BR); Sthefan Verjas de Almeida, Sao Bernardo Do Campo-Sp (BR); Fabio Riberio Pimentel, Joinville-SC (BR); Darlan Princival Junior, Joinville-SC (BR)

Correspondence Address: DARBY & DARBY P.C., P. O. BOX 5257, NEW YORK, NY, 10150-5257, US

(73) Assignee: Multibras S.A. Elletrodomesticos, Sao Paulo-SP (BR)

(21) Appl. No.: 10/535,538

(22) PCT Filed: Nov. 17, 2003
(86) PCT No.: PCT/BR03/00167

§ 371 Date: Nov. 1, 2005

(30) Foreign Application Priority Data
Nov. 25, 2002 (BR) PI 0205050-1

(51) Int. Cl. E05D 11/00

(52) U.S. Cl. 16/223

(57) ABSTRACT

An electric supply system for the door of refrigerators and freezers and other appliances comprising a cabinet (10) to which is articulated an end edge (21) of a door (20) carrying an electronic control means (30), comprising a connecting means (15) mounted to each region of the cabinet (10) that is foreseen to receive and affix a respective hinge (40); an auxiliary electric wiring (16) connecting each connecting means with an internal electric circuit of the appliance; a duct (22) provided in the door (20) and having an inlet (22a) opened to the interior of the door (20) and a pair of outlets (22b) opened to the outside of the end edge (21), one of them bearing a tubular hinge pin (42) of a respective hinge (40); an electric wiring (31) mounted through the duct (22) and the hinge pin (42) and having an internal end (32) connected with the electronic control means (30) and an external end (33) coupled to the connecting means (15) adjacent to the hinge (40).

### FIELD OF THE INVENTION

The present invention refers to a system to provide electric supply to electronic control means installed in reversible or non-reversible doors of refrigerators, freezers, and other appliances that comprise a cabinet closed by one or more front doors.

### PRIOR ART

There are well known from the art the refrigerators and freezers with a front door carrying an electronic control means, which allows the user to be informed about the operational parameters of the appliance and also to command the operation of the latter.

In the refrigerators and freezers presenting a front door of the non-reversible type as to its opening direction, the electric supply of the electronic control means is generally provided through the tubular pin of one of the hinges. The wiring connected to the electric circuit of the appliance is disposed through the structure of the cabinet, passing through the interior of the tubular pin of a hinge, and extending through the interior of the door until reaching the electronic control means to be energized. In the refrigerators and freezers presenting a construction that allows the opening direction of the door to be reverted in relation to the factory original assembly, there is known the solution of providing the electric supply of the electronic control means in the door through electromagnetic induction produced by a transformer with a two-piece core. In this solution, the primary of the transformer is mounted to the cabinet, while the secondary is installed in the door, making the electronic control means work only when the door is in the closed condition.

Another known solution for energizing the electronic control means installed in a reversible door utilizes contact pins, respectively mounted to the cabinet and to the door and which close the electric supply circuit of the electronic control means only when the door is closed. Besides only energizing the electronic control means when the door is closed, this prior art solution presents the limitation of operating with low power electric signals, due to the exposure of the contact pins when the door is opened.

### OBJECTS OF THE INVENTION

In view of the disadvantages mentioned above, it is the object of the present invention to provide an electric supply system for the door of refrigerators, freezers, and other appliances of similar structure, which allows an electronic control means provided in the door to be easily and safely energized, regardless of the condition and the opening direction of said door.

### SUMMARY OF THE INVENTION

The invention provides an electric supply system for the door of refrigerators, freezers, and other appliances comprising a cabinet to which is articulated an end edge of a door carrying an electronic control means.

According to the invention, the supply system comprises a connecting means mounted to each region of the cabinet designed to receive and affix a respective hinge provided with a tubular hinge pin, and an auxiliary electric wiring connecting the connecting means to an internal electric circuit of the appliance.

The door is provided with a duct having an inlet opened to the interior of the door and an outlet opened to the outside of the end edge of the door, in a coaxial position in relation to that foreseen for mounting the hinge pin of a respective hinge, as a function of the opening directions foreseen for the door; a tubular bushing provided in the outlet of the duct for receiving and bearing the hinge pin of the hinge; an electric wiring mounted through the duct, from its inlet to its outlet and through the hinge pin of the hinge, in order to have an internal end connected to the electronic control means and an external end coupled to the connecting means adjacent to the hinge.

### BRIEF DESCRIPTION OF THE DRAWINGS

The invention will be described below, with reference to the enclosed drawings, given by way of example of an embodiment of the invention and in which:

FIG. 1 is a front partial and exploded perspective view of the upper part of the cabinet of a refrigerator or freezer closed by a front door and provided with the electric supply system of the present invention;

FIG. 2 is a lateral partial perspective view of the upper part of the assembly illustrated in FIG. 1, showing the arrangement of the electric wiring of the door with its external end coupled to the connecting means mounted in the region of the cabinet where the upper hinge of the door is affixed;

FIG. 3 is an exploded perspective view of the parts that form an upper hinge and the upper finishing parts of the door, as well as those which define the receiving duct of the electric wiring of the door;

FIG. 4 is a somewhat schematic vertical sectional view of the upper portion of the door, taken according to the longitudinal axis of the duct;

FIG. 5 is an enlarged detail of the right-hand end portion of FIG. 4, illustrating the passage of the electric wiring through the upper hinge;

FIG. 6 is an enlarged, somewhat schematic vertical sectional view of the upper portion of the door, taken according to a direction that is orthogonal to the plane of the door and along the mounting longitudinal axis of the hinge to the cabinet; and

FIG. 7 is a perspective view of the upper part of the assembly illustrated in FIG. 1 with the component parts in the mounted condition.

### DETAILED DESCRIPTION OF THE INVENTION

As illustrated in the enclosed drawings and as mentioned above, the invention is directed to refrigerators, freezers, and other appliances provided with a generally parallelepipedic cabinet 10 that presents a front door 20 carrying an electronic control means 30, of any adequate construction, which operates as an interface between the refrigerator or freezer and the user, allowing him/her to verify and command the operation of the household appliance.

According to the proposed solution, the cabinet 10 has an upper face 11 provided with two housings 12 disposed close to the respective sides of the cabinet 10 in the region of the face of the latter designed to receive and affix a respective hinge 40.

In the illustrated exemplary construction, there are provided two housings 12, as the project of the household appliance foresees the possibility of the door 20 having its opening direction reverted in relation to that defined in the factory original assembly. It should be understood that in the cases in which the reversion of the opening direction of the door 20 is not foreseen, the upper face 11 of the cabinet 10 can be provided with only one housing 12 located in the mounting region of the upper hinge 40 of the door 20.

Inside each housing 12 there is mounted a connecting means 15 of any adequate construction and which is schematically illustrated, connected to the electric circuit (not illustrated) of the household electric appliance by means of an auxiliary electric wiring 16, schematically illustrated in dashed lines and which is mounted inside the walls that define the structure of the cabinet 10 by any of the well known prior art processes which do not belong to the present invention.

Each connecting means 15 is preferably mounted to the respective housing 12 in a lowered position in relation to the upper face 11 of the cabinet 10, so as to facilitate the finishing of the latter, as described below.

According to a further aspect of the invention, the connection between the electronic control means 30 and the internal electric circuit of the appliance is made by an electric wiring 31, constructed according to the working characteristics of the appliance and which presents an internal end 32 connected to the electronic control means 30 and an external end 33 constructed to be electrically coupled to the connecting means 15 adjacent to the hinge 40.

The electric wiring 31 is adequately mounted, according to any adequate process for this type of construction, through the interior of the structure of the door 20, projecting outwardly from the median region of the end edge 21 of the door 20 where is effected the articulation of said door 20 to the cabinet 10. In the illustrated construction, in which the door 20 is a front door, said end edge 21 is the upper edge defined by a finishing end cap that is fitted and affixed to the structure of the door 20.

This finishing end cap is generally a molded piece configured to complement a respective end portion of the door 20.

In order to allow the electric wiring 31 to be conducted from the electronic control means 30 to the respective connecting means 15, the door 20 is provided with a duct 22 having an inlet 22a opened to the inside of the door 20 and an outlet 22b opened to the outside of the end edge 21 of the door 20 in a position which is coaxial with each position foreseen for the hinge axis of the hinge 40. In the illustrated example, the duct 22 takes the form of a groove provided in the finishing end cap of the end edge 21 of the door 20. In the median region of said groove is defined the inlet 22a of the electric wiring 31 and its enlarged opposite ends define the outlets 22b of the electric wiring 31 of the door 20, each outlet 22b being coaxially aligned with the hinge axis of the hinge 40 to be mounted to the adjacent side of the cabinet 10.

As illustrated, the hinge 40 comprises a basic plate 41 to be seated and affixed, usually by screwing, onto the upper face 11 of the cabinet 10, and projecting outwardly from the contour of the latter, in order to incorporate a tubular hinge pin 42 having a free end projecting orthogonally from the basic plate 41, and an end incorporated to the latter and opened to the interior thereof.

It should be understood that the hinge 40 might be installed not only in the upper face 11 of the cabinet 10, but also in other parts of the structure of the latter, so as to allow installing the present electric supply system in other doors rather than those whose upper end edge is leveled with the upper face 11 of the cabinet 10.

To complement the hinge 40, there is provided a tubular bushing 45 presenting an end flange 46 and mounted in the interior of each outlet 22b of the duct 22, so as to receive in the interior thereof and rotatably support the hinge pin 42 of the hinge 40. The tubular bushing 45 can be constructed in different materials that facilitate its molding and present adequate strength and antifriction characteristics for bearing the hinge pin 42 of the hinge.

In the illustrated construction, the end flange 46 of the tubular bushing 45 is seated on the end edge 21 of the door 20, being there retained by a pair of locking tabs 46a, elastically deformable in the radial direction and which will be fitted and retained in respective housings 23 provided external to the outlets 22b of the duct 22.

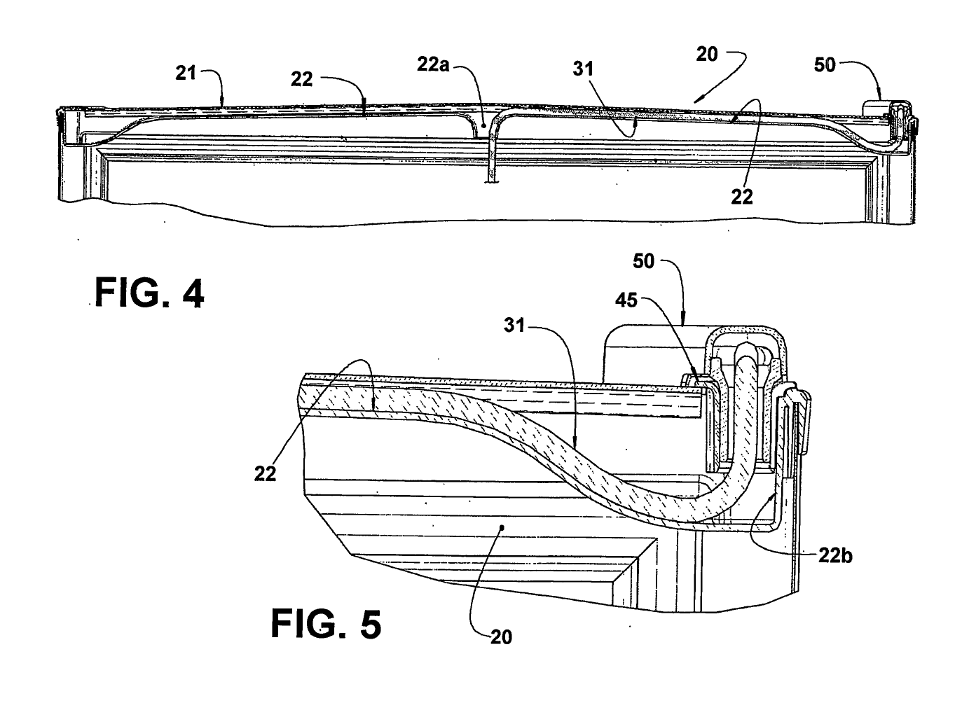

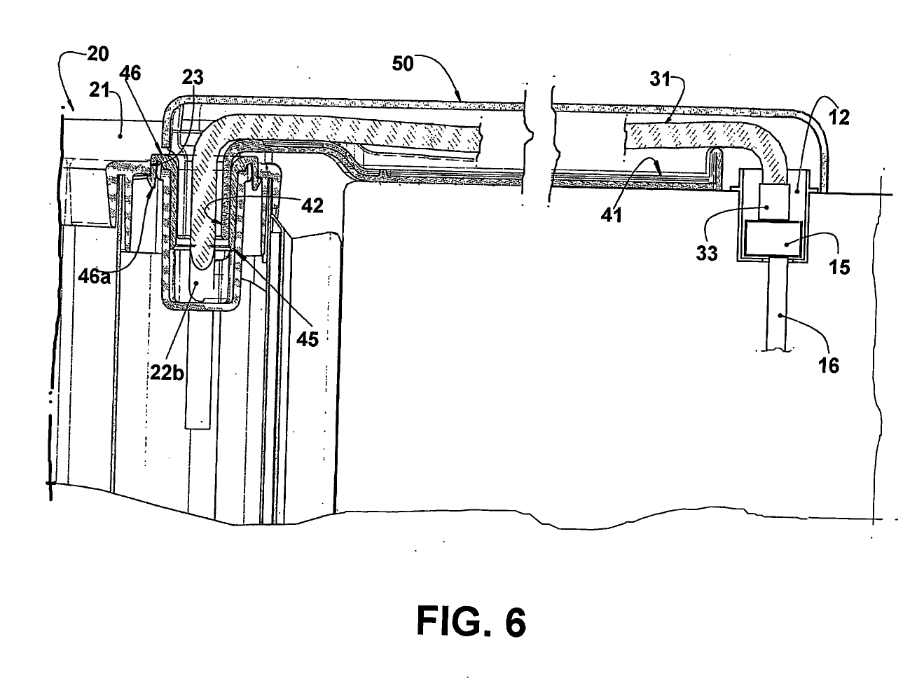

As better illustrated in FIGS. 4, 5 and 6, the duct 22 presents a greater depth in the end regions, in order to allow the electric wiring 31 coming from the inlet 22a to be orthogonally bent and inserted through both the tubular bushing 45 and the hinge pin 42 of the hinge 40, to be then seated on the basic plate 41 of the latter and have its external end 33 taken to the interior of the adjacent housing 12 so as to be coupled to the respective connecting means 15.

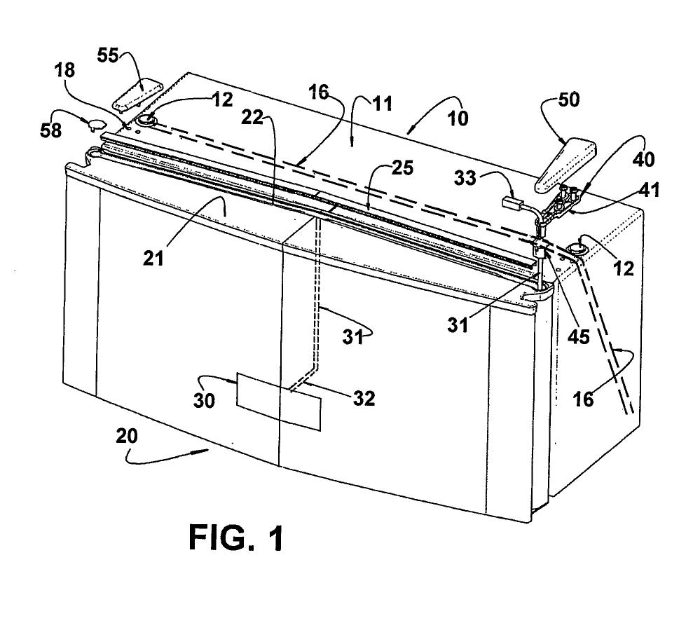

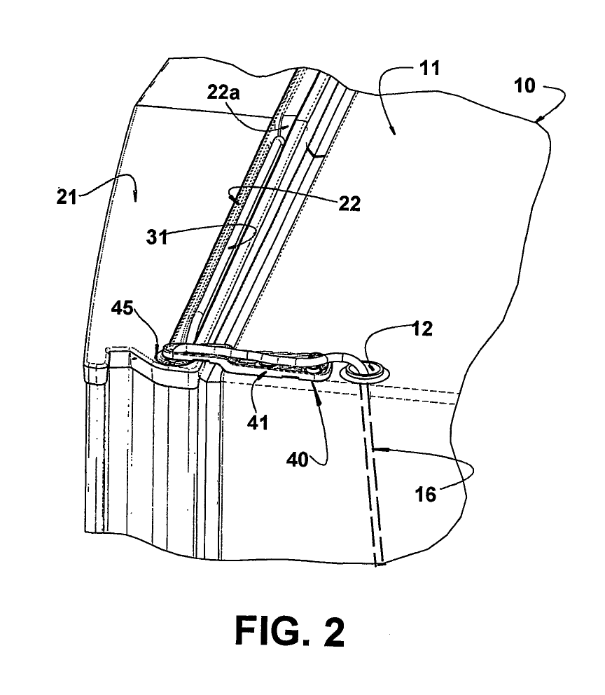

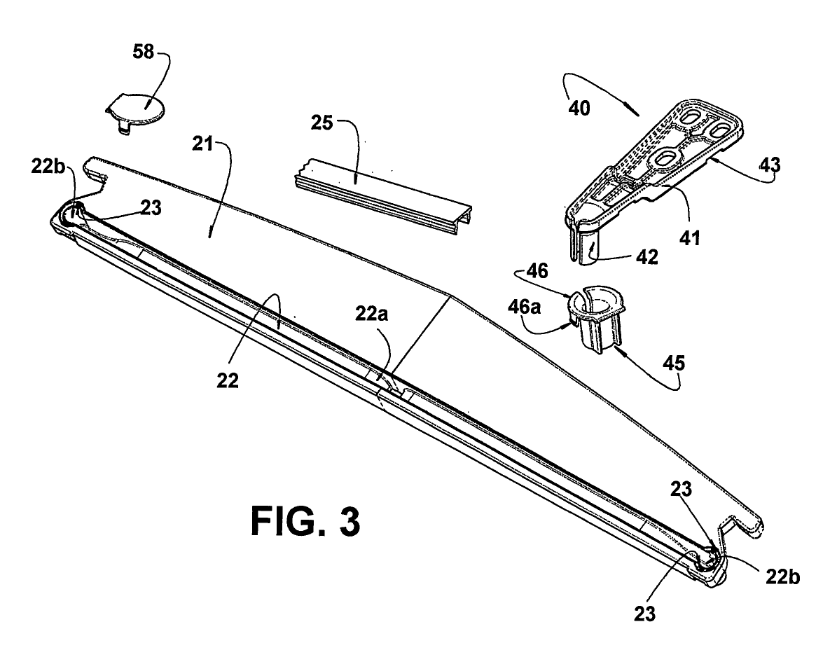

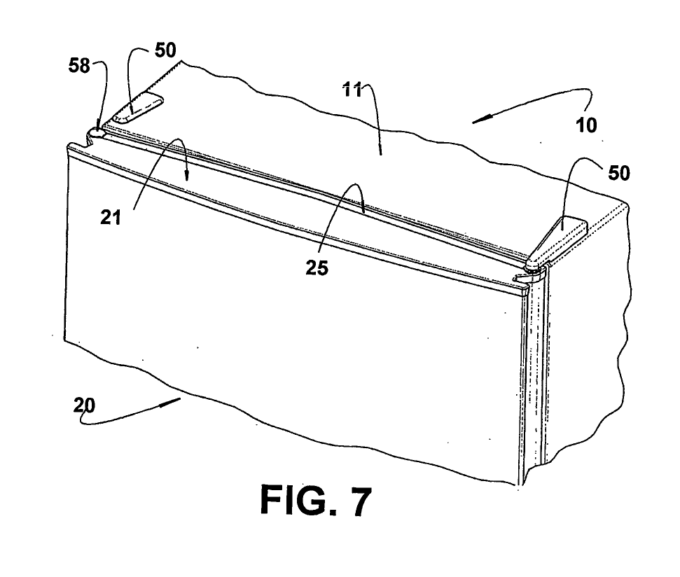

For finishing the assembly, there is provided a main cover 50 that is removably fitted over the hinge 40 so as to cover the basic plate 41 of the latter and also the adjacent housing 12 and the outlet 22b of the duct 22 through which the electric wiring 31 has been passed, as illustrated in FIGS. 1 and 7. The fixation of the main cover 50 can be achieved, by fitting internal teeth (not illustrated) into marginal recesses 43 of the basic plate 41. The bores 18 of the upper face 11 of the cabinet 10, which are located adjacent to the other housing 12 to receive the hinge 40 upon the reversion of the opening direction of the door 20, are covered with an auxiliary cover 55 constructed to be fitted in the adjacent housing 12, covering the latter and the bores 18 that secure the hinge 40.

In the rectilinear upper portion of the duct 22 is fitted a removable elongated cap 25, which is formed in one or more pieces preferably extruded in plastic material. The outlet 22b of the duct 22 opposite to that covered by the main cover 50 is superiorly closed by a small finishing cap 58 that is also removably fitted. The provision of the covers and the caps protects the assembly against the undue entry of water inside the cabinet 10 and the door 20.

As it can be noted from the description above, the present system allows using only one construction for the cabinet 10 and the door 20 to comply with the constructive particularities of the appliances of the type considered herein, whether they present or not an electronic control means 30 mounted to a front door. The proposed construction maintains the same characteristics, regardless of the presence of the electric wiring 31, of the auxiliary electric wiring 16, of the connecting means 15, and also of the side of the cabinet 10 onto which the hinge 40 will be mounted.

In order to revert the opening direction of the door 20, the only thing to do is to disassemble the hinge 40 of one of the sides, assembling it on the other side of the cabinet 10, executing the same operation in relation to the main cover 50 and auxiliary cover 55, caps 25, 58 and tubular bushing 45. The wiring 31 has its external end 33 uncoupled from a connecting means 15 and coupled to the connecting means 15 provided in the housing 12 on the other side of the cabinet 10, and the wiring 31 is seated on the other half of the duct 22. Thus, the reversion of the opening direction of the door may be effected by the user himself/herself, by using the same components of the factory original assembly, which do not require specific constructive features to be mounted, either to the right or to the left side. It is still possible, upon using the connecting means 15 on the right side (factory original condition), to de-energize the extension of the auxiliary electric wiring 16 that supplies the connecting means 15 on the left side.

While only one embodiment of the invention has been illustrated herein, it should be understood that changes could be made in the form and arrangement, without departing from the constructive concept defined in the claims that accompany the present specification.

1. An electric supply system for the door of refrigerators and freezers and other appliances comprising a cabinet (10) to which is articulated an end edge (21) of a door (20) carrying an electronic control means (30), characterized in that it comprises a correcting means (15) mounted to each region of the cabinet (10) which is foreseen to receive and affix a respective hinge (40) provided with a tubular hinge pin (42); an auxiliary electric wiring (16) connecting the connecting means with an internal electric circuit of the appliance; a duct (22) provided in the door (20) and having an inlet (22a) opened to the interior of the door (20) and an outlet opened (22b) to the outside of the end edge (21) of the door (20), in a coaxial position in relation to that foreseen for mounting the hinge pin (42) of a respective hinge (40), as a function of the opening directions foreseen for the door (20); a tubular bushing (45) provided at the outlet (22b) of the duct (22) for receiving and bearing the hinge pin (42) of the hinge (40); an electric wiring (31) mounted through the duct (22), from its inlet (22a) to its outlet (22b) and through the hinge pin (42) of the hinge (40), in order to have an internal end (32) connected with the electronic control means (30) and an external end (33) electrically coupled to the connecting means (15) adjacent to the hinge (40).

2. The electric supply system as set forth in claim 1, characterized in that the connecting means (15) is mounted inside a respective housing (12) provided on the face of the cabinet (10) to which the hinge (40) is affixed.

3. The electric supply system as set forth in claim 2, characterized in that there are provided two housings (12), each located close to a respective side of the cabinet (10) and housing a connecting means (15) connected to the auxiliary electric wiring (16).

4. The electric supply system as set forth in claim 1, characterized in that the duct (22) takes the form of a groove defined in the end edge (21) of the door (20) with which the hinge (40) cooperates, the inlet (22a) being defined at the bottom of the median region of the groove presenting widened opposite ends defining a pair of outlets (22b).

5. The electric supply system as set forth in claim 4, characterized in that the duct (22) in the form of a groove has its depth enlarged at its opposite end regions so as to lodge an orthogonal bending of the electric wiring (31).

6. The electric supply system as set forth in claim 4, characterized in that the end edge (21) of the door (20) is defined by a finishing end cap incorporating the duct (22) in the form of a groove.

7. The electric supply system as set forth in claim 4, characterized in that the duct (22) in the form of a groove is closed by an elongated cap (25) removably fitted into said duct (22).

8. The electric supply system as set forth in claim 7, characterized in that the widened end of the duct (22) opposite to that adjacent to the hinge (40) receives a small finishing cap (58) removably fitted therein.

9. The electric supply system as set forth in claim 1, characterized in that the hinge (40) comprises a basic plate (41) to be removably affixed to the cabinet (10), projecting outwardly from the contour of the latter so as to incorporate therein a tubular hinge pin (42), to be rotatably supported in the interior of the adjacent outlet (22b) of the duct (22).

10. The electric supply system as set forth in claim 9, characterized in that the hinge pin (42) of the hinge (40) is rotatably supported inside a tubular bushing (45) that is fitted and retained inside the adjacent outlet (22b) of the duct (22).

11. The electric supply system as set forth in claim 10, characterized in that the tubular bushing (45) incorporates an end flange (46) to be seated onto the end edge (21) of the door (20).

12. The electric supply system as set forth in claim 11, characterized in that the tubular bushing (45) incorporates locking tabs (46a) in its end flange (46), elastically deformable in the radial direction so as to be fitted and retained in respective housings (23) provided external to the outlets (22b) of the duct (22).

13. The electric supply system as set forth in claim 9, characterized in that it comprises a finishing main cover (50) which is removably fitted over the hinge (40), in order to cover the basic plate (41) of the latter and the adjacent housing (12) and outlet (22b) of the duct (22).

14. The electric supply system as set forth in claim 13, characterized in that it further comprises an auxiliary cover (55), removably fitted in the housing (12) away from the hinge (40) and which covers said housing (12) and the adjacent bores (18) of the cabinet (10), for mounting said door (20) upon the reversion of its opening direction.
